(19) United States
(12) Patent Application Publication
(10) Pub. No.: US 2006/0245432 A1
(43) Pub. Date: Nov. 2, 2006

(54) Method and apparatus for depicting quality of service by base station in mobile networks

(76) Inventors: Robert H. Kroboth, Peyton, CO (US); Per Kangru, Copenhagen (DK); Juergen Voss, Wiesbaden (DE)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/116,647

(22) Filed: Apr. 28, 2005

(51) Int. Cl. H04L 12/56

(52) U.S. Cl. 370/395.21

(57) ABSTRACT

A method of displaying quality of service information based on data collected from a system under test. At least one base station related to the collected data is identified and for each time interval a quality of service value is calculated for each of the at least one base station. The quality of service values are compared to at least one defined threshold and a relationship between the quality of service values and the at least one defined threshold is displayed.

### BACKGROUND OF THE INVENTION

Third-generation wireless communication systems (generally referred to as 3 G systems) are currently being designed, built and placed into operation. 3 G systems are typically defined by broadband packet-based transmission of data, including: text; voice; video; and multimedia, at data rates up to and possibly higher than 2 megabits per second (Mbps). One example of a 3 G system is the Universal Mobile Telecommunications System (UMTS).

One example of a 3 G system is the Universal Mobile Telecommunications System (UMTS). UMTS is an evolving system being developed within the International Telecommunications Union (ITU) IMT-2000 framework. UMTS was generally conceived to be a follow-on network to the group special mobile (GSM) networks that dominate Europe. UMTS employs a 5 MHz channel carrier width to deliver significantly higher data rates and increased capacity compared with second-generation networks. This 5 MHz channel carrier provides optimum use of radio resources, especially for operators who have been granted large, contiguous blocks of spectrum—typically ranging from 2×10 MHz up to 2×20 MHz—to reduce the cost of deploying 3 G networks. Universally standardized via the Third Generation Partnership Project (3 GPP—see www.3gpp.org) and using globally harmonized spectrum in paired and unpaired bands, 3 G/UMTS in its initial phase offers theoretical bit rates of up to 384 kbps in high mobility situations, rising as high as 2 Mbps in stationary/nomadic user environments. Symmetry between uplink and downlink data rates when using paired (FDD) spectrum also means that 3 G/UMTS is ideally suited for applications such as real-time video telephony.

Test and measurement systems are available for monitoring and trouble-shooting various connections and devices in emerging 3 G systems. In today's highly competitive telecommunications arena, customer demands for increased network reliability and performance must be balanced against the cost of operating and maintaining the network to support the higher level of desired service. A variety of network and signal test and measurement products are available from a variety of vendors that attempt to maximize the time and resources devoted to planning, troubleshooting, installing, and maintaining modern day packet and signaling networks.

As service providers build their networks and obtain compliance with one or more of the 3 G standards they desire apparatus and methods to measure and control reliability and performance of the networks. Quality of Service (“QoS”) generally refers to the capability of a network to provide a selected level of service to a selected number of customers. QoS handling is one of the underlying concepts of the system specifications drawn up by the Third Generation Partnership.

To maximize revenue, many operators offer increased levels of QoS for increased costs. Once a level of QoS has been agreed upon, it is advantageous for the network provider to be able to monitor the network with an eye to measurements of events that have an affect the QoS. Such monitoring facilitates better maintenance of the network, minimizes questions about fees charged under the agreement and allows the network operator to optimize system traffic. Accordingly providers of test and measurement systems incorporate QoS measurement methods and apparatus into their hardware and software.

Current measurements techniques focus on measuring and analyzing end-to-end performance in an attempt to model performance from a customer's perspective. Once a problem is identified, a technician must drill down into a mountain of configuration data and test results in an attempt to isolate problems. The present inventors have recognized a need for a graphical display that provides QoS data as related to individual pieces of equipment, for example individual base stations. Further, there is a need for enhanced display methodologies that manages many data components in a manner more accessible to a user.

### BRIEF DESCRIPTION OF THE DRAWINGS

An understanding of the present invention can be gained from the following detailed description of the invention, taken in conjunction with the accompanying drawings of which:

FIG. 1 is a block diagram of a network analysis system upon which methods in accordance with a preferred embodiment of the present invention may be practiced.

FIG. 2 is a flow chart of a method in accordance with a preferred embodiment of the present invention.

FIG. 3 is an illustration of a graphical display formulated in accordance with a preferred embodiment of the present invention.

### DETAILED DESCRIPTION

Reference will now be made in detail to the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, general purpose personal computers and the like. These descriptions and representations are the means used by those skilled in the art to effectively convey the substance of their work to others skilled in the art.

A method is here, and generally, conceived to be a sequence of steps or actions leading to a desired result, and as such, encompasses such terms of art as “routine,” “program,” “objects,” “functions,” “subroutines,” and “procedures.” The methods recited herein may operate on a general purpose computer or other network device selectively activated or reconfigured by a routine stored in the computer and interface with the necessary signal processing capabilities. More to the point, the methods presented herein are not inherently related to any particular device; rather, various devices may be used to implement the claimed methods. Machines useful for implementation of the present invention include those manufactured by such companies as AGILENT TECHNOLOGIES, INC. and HEWLETT PACKARD, as well as other manufacturers of computer and network equipment.

With respect to the software described herein, those of ordinary skill in the art will recognize that there exist a variety of platforms and programming languages for creating software for performing the methods outlined herein. Embodiments of the present invention can be implemented using any of a number of varieties of programming languages, JAVA being one example, however, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a microprocessor, but can also be implemented in other types of processors. For example, the methods could be implemented with HDL (Hardware Design Language) in an ASIC (application specific integrated circuits). In addition, the solution may be implemented in a single computer or could span multiple computers with each performing a subset of the tasks.

The following description will use nomenclature associated with a UMTS system, however those of ordinary skill in the art will recognize that the present invention is applicable to any wireless system that transmits data via ATM or TCP/IP, including any 3 G system, most 2.5 G systems and many 1 G systems. It is anticipated that most future systems would benefit from the present invention, including the embodiments thereof described herein.

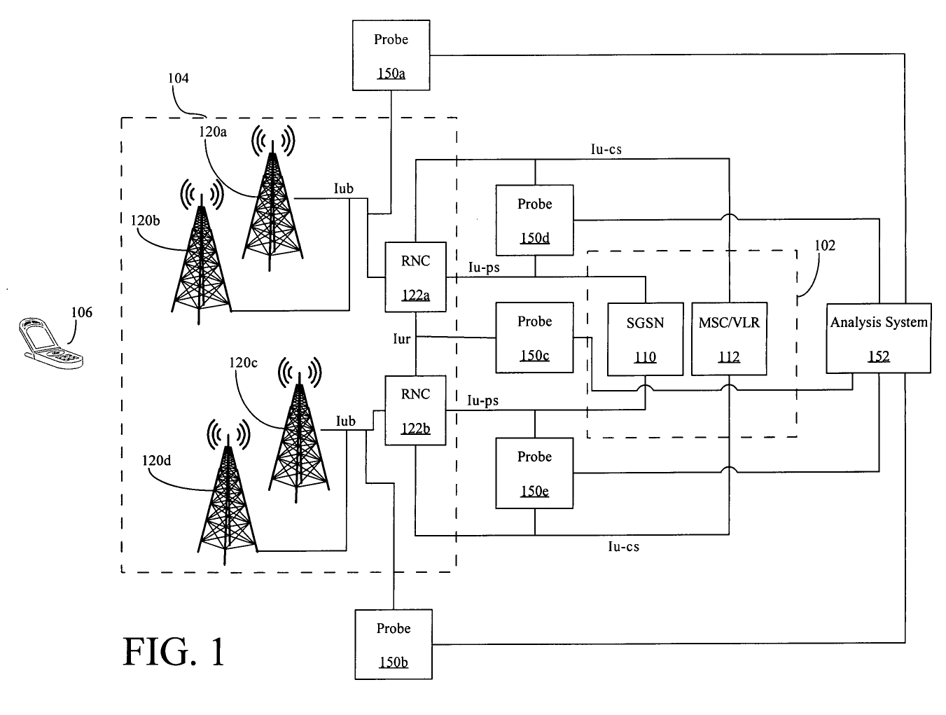

FIG. 1 is a block diagram of a network analysis system upon which methods in accordance with a preferred embodiment of the present invention may be practiced. More specifically, FIG. 1 illustrates the use of AGILENT TECHNOLOGIES' NETWORK ANALYZER family of products as applied to a UMTS network. Those of ordinary skill in the art will recognize that the methods of the present invention may be applied to test and measurement systems from other vendors and used on other networks.

FIG. 1 illustrates a distributed test and measurement system applied to a UMTS network 100. The UMTS network 100 generally comprises Core Network (CN) 102, a UMTS Terrestrial Radio Access Network (UTRAN) 104 and User Equipment (UE) 106. The main function of the CN 102 is to provide switching, routing and transit for user traffic. The CN 102 also contains hardware and software for managing databases and performing network management functions. The UTRAN 104 provides the air interface access method for UE 106. The UE 106 generally comprises a cell phone or other personal communication device. In the configuration shown in FIG. 1, the CN 102 generally comprises: one or more serving GPRS support nodes (SGSN) 110 and one or more mobile switching centers 112. The UTRAN 104 generally comprises one or more Node-B's 120n and one or more RNC's 122n.

The connections among and between the various constituent parts of a UMTS network 100 are facilitated by interfaces. For example, the air interface between the node B's 120n and the user equipment 106 is referred to as a Uu interface and generally conforms to the WCDMA air interface. Similarly, communication between node B's 120n and the RNC's 122n are facilitated by Iub interfaces. Unlike GSM, UMTS specifies an interface between RNC's 112n, termed the Iur interface. The interface between the RNC's 122n and the core network are generally termed an Iu interface. In at least the first iteration of the UMTS standard, separate Iu interfaces for circuit switched and packet switched connections are specified, termed Iu-cs and Iu-ps respectively. At least in the initial versions of UMTS, each of the wired interfaces are based on asynchronous transfer mode (ATM) technology.

Probes 150n monitor signaling protocol communications sent within the UMTS 100. The probes 150n may comprise any of a variety of network monitors such as, but not limited to, the probes in the Agilent Distributed Network Analyzers family of products. One example of a signaling protocol utilized in the UMTS 100 is the Access Link Control Application Part protocol (ALCAP). Generally, the probes 150n passively and actively monitor and gather messages passed over the various interfaces, such as the IUB, IU, and IUR link. The connections illustrated in FIG. 1 for the probes 150n are logical, it being recognized that the physical connections may follow a different topology. Thus, the probe 150a monitors the Iub interface between the RNC 222a and the node-B's 120a and 120b. The probe 150b monitors the Iub interface between the RNC 122b and the node-B's 120c and 120d. The probe 150c monitors the Iur interface between the RNC 122a and the RNC 122b. Lastly, the probes 150d and 150e monitor the Iu interfaces between the RNC's 122a and 122b, respectively, with the core network 102. An analysis system, 152 receives messages from the probes 150n, analyzes the messages, and provides information related to the signaling operation of the UMTS system 100. The analysis system may, for example, comprise an AGILENT SIGNALING ANALYZER. Analysis systems from other providers, including those integrated with probes, may also be utilized with the present invention.

The AGILENT TECHNOLOGIES' SIGNALING ANALYZER provides a distributed testing and analysis solution that maximizes the time and resources devoted to planning, troubleshooting, installing, and maintaining modern day networks. The modular design and flexibility of Signaling Analyzer solutions allows technology teams to identify potential problems and resolve faults quickly and effectively—with product configurations to exactly match engineers' differing needs. In particular, the Signaling Analyze—Real-time (Agilent part number J7326A) enables key personnel to see network problems as they occur and turns what can be an overwhelming amount of diagnostic data into usable information. For maximum interface flexibility, the Signaling Analyzer—Real-time uses the same well-proven data acquisition module with hot-swappable Line Interfaces (Agilent part number J6801A) as Agilent's other distributed network analysis solutions. Alternatively, the Signaling Analyzer-Software Edition (Agilent Part Number J5486B) can be used off-line for post-capture analysis. Further, while a distributed system may simplify many of the problem surrounding the installation and use of a measurement system, the present invention may be practiced on non-distributed system, including those offered by such vendors as Tektronix Inc.

As noted, QoS concepts have been incorporated into 3 G standards. The 3 GPP has defined four QoS classes: conversational; streaming; interactive; and background. Table 1 compares the four different traffic classes in UMTS:

TABLE 1

| | Conversational | | | Background |
|---|---|---|---|---|
| Traffic class | class | Streaming class | Interactive class | class |
| Fundamental | Real Time | Real Time | Best Effort | Best Effort |
| characteristics | Preserve time | Preserve time | Request | Destination is |
| | relation (variation) | relation | response pattern | not expecting |
| | between | (variation) | Preserve | the data within a |
| | information | between | payload content | certain time |
| | entities of the | information | | Preserve |
| | stream | entities of the | | payload content |
| | Conversational | stream | | |
| | pattern (stringent | | | |
| | and low delay) | | | |
| Example of the | voice | streaming video | web browsing | telemetry, |
| application | | | | emails |

In UMTS, the QoS architecture relies on bearer services characterized by QoS attributes. Bearer services are defined between various points in the system. The Radio Access Bearer (RAB) is defined between the UE and the core network. The RAB in turn relies upon two other bearer services: the Radio Bearer service between the user equipment and the UTRAN; and the Iu Bearer service between the UTRAN and the core Network. A Core Network (CN) Bearer service is defined between the UTRAN and external fixed networks, such as the Public Switched Network (PTSN). The UMTS Bearer service extends between the UE and external fixed networks, thus relying on the RAB and CN Bearer services.

To realize a certain network QoS, a Bearer Service with clearly defined characteristics and functionality must be set up from the source to the destination of a service. For example, Table 2 illustrates the UMTS Bearer Service Attributes relationship with the four traffic classes. Many of these characteristics may also be monitored by probes to generate measurements indicative of QoS.

TABLE 2

| | Conver- | Stream- | Inter- | Back- |
|---|---|---|---|---|
| Traffic Class | sational | ing | active | ground |
| Maximum Bit Rate | X | X | X | X |
| Delivery Order | X | X | X | X |
| Maximum Service Data | X | X | X | X |
| Unit (SDU) size | | | | |
| SDU Format Information | X | X | | |
| SDU Error Rate | X | X | X | X |
| Residual Bit Error Rate | X | X | X | X |
| Delivery of Erroneous SDU's | X | X | X | X |
| Transfer Delay | X | X | | |
| Guaranteed Bit Rate | X | X | | |
| Traffic Handling Priority | | | X | |
| Allocation/Retention Priority | X | X | X | X |

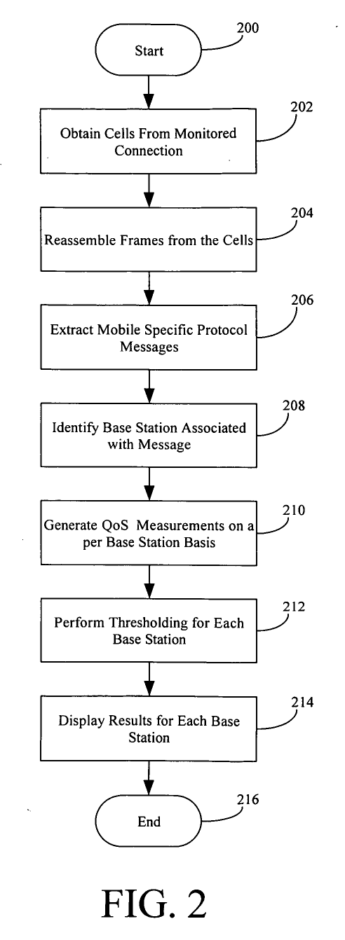

FIG. 2 is a flow chart of a method in accordance with a preferred embodiment of the present invention. The method portrayed in FIG. 2 is based on the current specified interfaces, most of which are based on ATM technology. It is to be recognized that the present invention is applicable to other complimentary and non-complimentary technologies, including TCP/IP. The method starts in step 200. In step 202, ATM cells are obtained from a monitored connection. The cells may be obtained using a probe, such as an Agilent Distributed Network Analyzer, or other test and measurement device. In step 204, the cells are reassembled into ATM Adaptation Layer (AAL) frames. Reassembly may be performed in the probe, the analysis system 152, or, as is the case with the Agilent DNA, in the Line Interface Module (LIM).

Next, in step 206, mobile specific protocol messages are extracted. In ATM, the AAL adapts the different classes of applications to the ATM layer. Four types of AALs have been defined, of which two AAL2 and AAL5 are typically utilized by mobile specific protocols. AAL2 supports connection-oriented services that do not require constant bit rates. In other words, variable bit rate applications like some video schemes. AAL5 supports connection-oriented variable bit rate data services without error recovery or built in retransmission. This tradeoff provides a smaller bandwidth overhead, simpler processing requirements, and reduced implementation complexity. Reassembly of ATM cells is described in co-pending U.S. patent application Ser. No. 10/791,117, assigned to the assignee of the present application and incorporated herein by reference.

In step 208, for each message stream, a base station from which the message stream started or ended is identified. Base station identification may be performed based on the RNC interface to which the probe is connected and the VPI/VCI (virtual path identifier/virtual channel identifier) identified in the headers of the message stream. Each VPI/VCI for any given RNC will be unique to a base station. In one embodiment, a table is created with an entry for each probe relating VPI/VCI's for each connected RNC. Table 3 is a sample of a user configurable table that may be used to relate base stations to a particular message on a particular probe.

TABLE 3

| | | | Node B |
|---|---|---|---|
| Probe | RNC | VPI/VCI | (Base Station) |
| Probe 1 | 12 | 0/35-38, 40 | Pelham |
| Probe 1 | 12 | 0/25-27 | Windham |
| Probe 1 | 12 | 4/14, 16-17 | Salem |
| Probe 1 | 12 | 5/36-38, 40 | Hudson |
| Probe 2 | 54 | 0/15-19 | Londonderry |
| Probe 2 | 54 | 0/35, 37-40 | Derry |
| Probe 3 | 22 | 0/25-30 | Dracut |
| Probe 3 | 22 | 2/15-19 | Metheun |
| Probe 3 | 22 | 2/16-19 | Tyngsboro |

Please note that in Table 3 it is assumed that each probe is associated with a single RNC, however that need not be the case as many probes have multiple ports. Further, as standards evolve, it may be expected that each base station will be assigned an Internet Protocol address and that communication with such base stations will adhere to TCP/IP standards. In this case, identification of base stations may be made cross-referencing the IP address to the base station identification.

In step 210, measurements based on the extracted protocol messages are formulated on a per base station basis. Thereafter, measurements are generated based on an analysis of the extracted protocol messages. Measurements generally comprise data and context. The context may be a time stamp with an identification of the probe producing the measurement. The data may comprise raw data striped from the signal or some quantitative piece of information, e.g. a key performance indicator (KPI), about the signal. A variety of software and/or hardware products exist that analyze signal protocol message to generate measurements. One example of suitable software is the AGILENT SIGNALING ANALYZER software product. Examples of measurements suitable for determining QoS of individual bases stations include: Uplink Block Error Rate (BLER), RLC throughput Uplink/Downlink for acknowledged mode RLC, # of Radio Link failures, # of RRC Connection Failed etc . . . .

In step 212, thresholding is performed on the measurements. Thresholding is a known process incorporated into a variety of test and measurement products. In general, thresholding comprises comparing measurements against one or more defined threshold values. For example, two thresholds may be defined to provide three levels of comfort: normal, abnormal (but usually acceptable), and critical (requiring immediate action to correct). Depending on the measurements formulated in step 210, it may prove beneficial to aggregate the measurements into a single value for each defined time interval and use the aggregated measurement for thresholding. Aggregation may be performed using a variety of algorithms, including: select best, select worst, calculate average, sum, calculate median, etc . . . .

Results of the thresholding are displayed in step 214 and the method ends in step 216. In general, such a display should illustrate the relationship between the threshold values and the measurements (or aggregated measurements). One example of a thresholding display comprises creating a time graph with the various threshold values indicated a lines extending across the graph. Measurements are plotted as lines on the graph over time. Another example is a health graph wherein an icon is displayed for each time period indicating the highest threshold exceeded during that time period. Generally, the icons comprise simple green/yellow/red colored shapes. Events may also be defined and triggered when a threshold is exceeded, e.g. a log message for exceeding the first threshold into abnormal operation and the generation of a trouble ticket for exceeding the second threshold into the critical problem region.

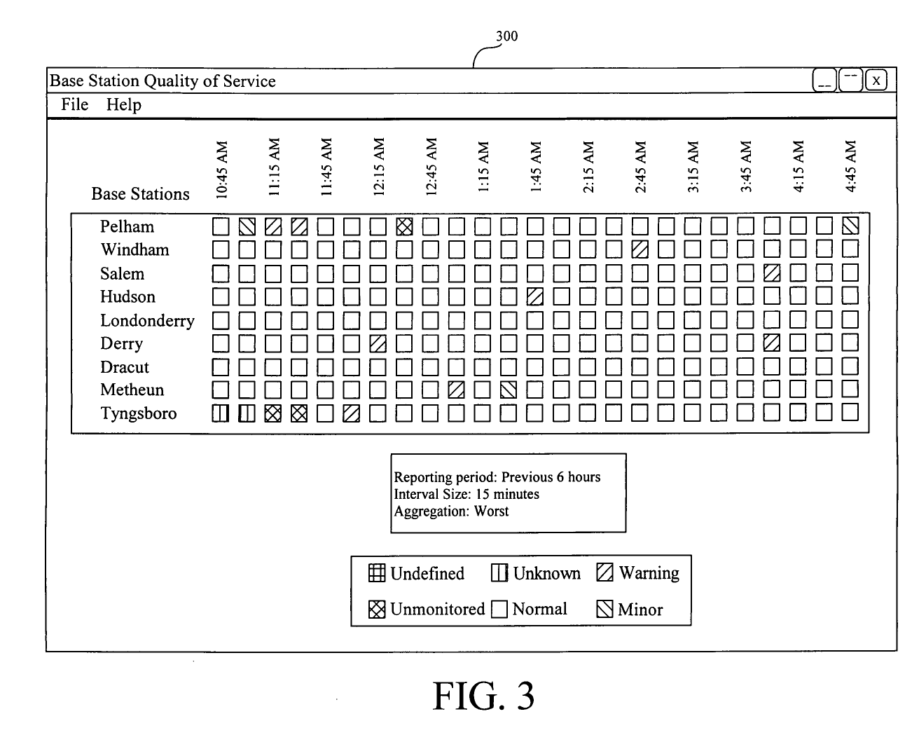

FIG. 3 is an illustration of a graphical display 300 formulated in accordance with a preferred embodiment of the present invention. The graphical display 300 illustrates a health graph wherein the health of each base station is graphically displayed as a colored icon. This allows an operator to quickly identify a candidate for further investigation.

Although some embodiments of the present invention have been shown and described, it will be appreciated by those skilled in the art that changes may be made in these embodiments without departing from the principles and spirit of the invention, the scope of which is defined in the claims and their equivalents. For example, while the present invention has been described with reference to an UMTS system, the teaching herein are also applicable to other 3 G, 2 G and 4 G systems including: CDMA2000, GSM, iDEN, GPRS, and EDGE.

What is claimed is:

1. A method of displaying quality of service information, the method comprising:
collecting data from a system under test;
identifying at least one base station related to the collected data;
for each time interval, calculating a quality of service value for each of the at least one base station based on the base station's related collected data;
comparing the quality of service values to at least one defined threshold; and
displaying the relationship between the quality of service values and the at least one defined threshold.

2. A method, as set forth in claim 1, wherein the step of displaying the relationship comprises:
displaying an icon indicating the level of QoS compliance of the at least one base station for each time interval.

3. A method, as set forth in claim 1, wherein the at least one base station comprises a plurality of base stations.

4. A method, as set forth in claim 1, wherein the at least one base station is identified based on the identification of a radio network controller associated with the collected data and a VPI/VCI of the channel from which the data was colleted.

5. A method, as set forth in claim 1, wherein the at least one base station is identified based on an IP address.

6. A method, as set forth in claim 1, wherein the step of displaying comprises displaying a health graph for each of the at least one base station(s).

7. A method, as set forth in claim 1, wherein the step of displaying comprises displaying a line graph for each of the at least one base station(s).

8. A method, as set forth in claim 7, further comprising displaying thresholds in association with the line graph(s).

9. A system for displaying an indication of quality of service, the system comprising:
a probe that monitors communication in a mobile communication system;
an analyzer that monitors communication to and from a plurality of base stations and identifies messages with a related base station; and
a graphical user interface that displays an indication of the quality of service for each of the plurality of base stations.

10. A system, as set forth in claim 9, wherein the plurality of base stations are identified based on the identification of a radio network controller associated the message and a VPI/VCI of the channel from which the data was colleted.

11. A system, as set forth in claim 9, wherein the plurality of base stations are identified based on an IP address.

12. A system, as set forth in claim 9, wherein the graphical user interface displays a health graph for each base station.

13. A system, as set forth in claim 9, wherein the graphical user interface displays a line graph for each base station.

14. A system, as set forth in claim 13, wherein the graphical user interface further displays thresholds in association with the line graphs.

15. A system comprising:
a probe that monitors communication in a mobile communication system;
an analyzer that monitors communication to and from a plurality of base stations and correlates individual messages with a related base station; and
a graphical display that outputs a display illustrating measurements on a per base station basis.
